(19) United States
(12) Patent Application Publication
(10) Pub. No.: US 2006/0208875 A1
(43) Pub. Date: Sep. 21, 2006

(54) Dimension measuring system

(76) Inventor: Masato Ebihara, Tsuchiura (JP)

Correspondence Address: CHRISTIE, PARKER & HALE, LLP, PO BOX 7068, PASADENA, CA, 91109-7068, US

(21) Appl. No.: 11/329,810

(22) Filed: Jan. 10, 2006

(30) Foreign Application Priority Data
Jan. 31, 2005 (JP) 2005-023194

(51) Int. Cl. G08B 1/08

(52) U.S. Cl. 340/539.1

(57) ABSTRACT

A dimension measuring system comprising a portable dimension measuring device having a terminal radio device, a dimension measuring section, and a display unit for displaying a dimension measurement and enabling the use of a portable measuring section even in a place where radio communication is not available, has been disclosed. The portable dimension measuring device comprises a radio communication state detection circuit for detecting whether communication is possible and, when in a state of not being capable of communicating with the base radio device, displays the generated dimension measurement on the display unit and, when a state of being capable of communicating with the base device is brought about, automatically resumes the operation of transmission of the generated dimension measurement to the base device.

### BACKGROUND OF THE INVENTION

The present invention relates to a dimension measuring system comprising a portable dimension measuring device that measures dimensions, such as inner diameters, outer diameters and depths, and a base device that collects dimension measurements measured by the portable dimension measuring device by radio communication.

In a machining device or processing device, the state of machining or processing is managed by measuring dimensions of each portion such as inner diameters, outer diameters, and depths. A conventional, general dimension measuring device is a type which an operator holds and performs measurement by positioning its measuring section at a portion to be measured, and which has a display unit for displaying a measurement in an analog or a digital form. Further, there is a type of device comprising a base device for producing a display and a measuring section connected to the base device by a cable, wherein measurement is performed by positioning the measuring section at a portion to be measured.

In contrast to this, in order to manage a manufacturing process more precisely, a dimension measuring system for collecting dimension measurements by a computer and analyzing the collected data is used. A dimension measuring system comprises a computer, a base device connected to the computer such that data communication is possible, and a measuring section connected to the base device by a cable. Generally, a base device has a display unit for displaying a dimension measurement but, when the display function of a computer is used for the display of a dimension measurement, there may be a case where a base device is not provided and a measuring section is directly connected to a computer by a cable. Here, a base device and a computer are together referred to as a base device. Further there may be a case where a measuring section has a display unit for displaying a dimension measurement or a case where plural measuring sections are connected to one base device.

In the above-mentioned dimension measuring system, as the measuring section and the base device are connected by a cable, when a large-sized automobile part such as a cylinder block is measured by the measuring section, because of the obstructive cable attached to the measuring section, it is necessary to take out the part from the machining line and move it onto a dedicated inspection base for inspection. Further, breakage of the cable connecting the measuring section and the base device is likely to occur. Therefore, it is proposed that measurement data is transferred between the measuring section and the base device by radio communication. A connection by radio communication can solve the above-mentioned problems.

### SUMMARY OF THE INVENTION

When connecting a portable measuring section and a base device by radio communication, the possible distance for radio communication between the portable measuring section and the base device is limited to, for example, about 10 m because of the strength of electromagnetic waves, the presence of obstructions, etc. For a conventional dimension measuring system in which a portable measuring section and a base device are connected by radio communication, establishment of radio communication between the base device and the portable measuring section is required for operation as a premise and therefore, when radio communication cannot be performed, measurement cannot be performed. As described above, even if no cable is connected and the portable measuring section can be carried freely, there is a problem that the range of use is limited.

The present invention will solve these problems and the object thereof is to make it possible to use a portable measuring section even where radio communication is not available in a dimension measuring system in which the portable measuring section and a base device are connected by radio communication.

In order to realize the above-mentioned object, in a dimension measuring system in a first aspect of the present invention, a portable measuring section is provided with a display unit for displaying a dimension measurement and, when in a state of not being capable of radio communication with a base device, the portable measuring section stops the operation of transmission of a dimension measurement to the base device and displays a dimension measurement on the display unit and, when in a state of being capable of radio communication with the base device, performs the operation of transmission of a dimension measurement to the base device.

In other words, the dimension measuring system in the first aspect of the present invention comprises a portable dimension measuring device having a terminal radio device, a dimension measuring section for generating dimension measurements, and a display unit for displaying the dimension measurements and a base device having a base radio device for radio communication with the terminal radio device, wherein the portable dimension measuring device is a dimension measuring system for transmitting the generated dimension measurements to the base device and the portable dimension measuring device comprises a radio communication state detection circuit for detecting whether the terminal radio device is capable of communicating with the base radio device and when in a state of not being capable of communicating with the base radio device, automatically stops the operation of transmission of the generated dimension measurements to the base device and at the same time, displays the generated dimension measurements on the display unit and, when a state of being capable of communicating with the base radio device is brought about, automatically resumes the operation of transmission of the generated dimension measurements to the base device.

According to the first aspect of the present invention, when in a state of not being capable of radio communication with the base device, the measuring section stops the operation of transmission of a dimension measurement to the base device, however, it displays the dimension measurement on the display unit, therefore, it is possible for an operator to operate the measuring section while watching the display unit.

Further, in order to realize the above-mentioned object, in a dimension measuring system in a second aspect of the present invention, a dimension measuring section comprises a measurement storage circuit for storing a dimension measurement and stores the dimension measurement in the measurement storage circuit when in a state of not being capable of communicating with the base radio device.

In other words, the dimension measuring system in the second aspect of the present invention is a dimension measuring system comprising a portable dimension measuring device having a terminal radio device and a dimension measuring section for generating a dimension measurement and a base device having a base radio device for performing radio communication with the terminal radio device, the portable dimension measuring device transmitting a generated dimension measurement to the base device, wherein the portable dimension measuring device comprises a radio communication state detection circuit for detecting whether the terminal radio device is capable of communicating with the base radio device and a measurement storage circuit for storing the dimension measurement, and stores the dimension measurement in the measurement storage circuit when in a state of not being capable of communicating with the base radio device.

According to the second aspect of the present invention, when in a state of not being capable of communicating with the base radio device, the measuring section stores a dimension measurement in the measurement storage circuit and, therefore, a dimension measurement in a state of not being capable of communication can also be utilized effectively. The stored dimension measurement is transmitted from the measuring section to the base device automatically or in accordance with a switch operation when a state of being capable of communicating with the base device is brought about.

By the way, the first aspect and the second aspect of the present invention can be applied in combination.

It is preferable for the portable dimension measuring device to comprise a display unit for indicating whether or not communication with the base radio device is possible in order to inform an operator of the state of radio communication.

It is preferable for the portable dimension measuring device to be driven by a battery from the standpoint of operability.

Further, a dimension measuring system may be possible in which plural portable dimension measuring devices are connected to one base device by radio communication.

According to the present invention, a portable measuring device can be used even in a place where communication is not possible in a dimension measuring system in which the portable measuring device and a base device are connected by radio communication and, therefore, the limit to the range of use is eliminated and the usability is improved.

### BRIEF DESCRIPTION OF THE DRAWINGS

The features and advantages of the invention will be more clearly understood from the following description taken in conjunction with the accompanying drawings, in which:

FIG. 1 is a diagram showing the entire configuration of a dimension measuring device of the present invention;

FIG. 2 is a diagram showing the detail of a bar graph display of a column;

FIG. 3 is a diagram showing an operation section of a hand gage;

FIG. 4 is a diagram showing a configuration of a computer system of a column;

FIG. 5 is a diagram showing a configuration of a computer system of a hand gage;

FIG. 6 is a flow chart showing a mode transition operation of a hand gage in an embodiment; and

FIG. 7 is a flow chart showing a modification example of a mode transition operation of a hand gage in an embodiment.

### DESCRIPTION OF THE PREFERRED EMBODIMENTS

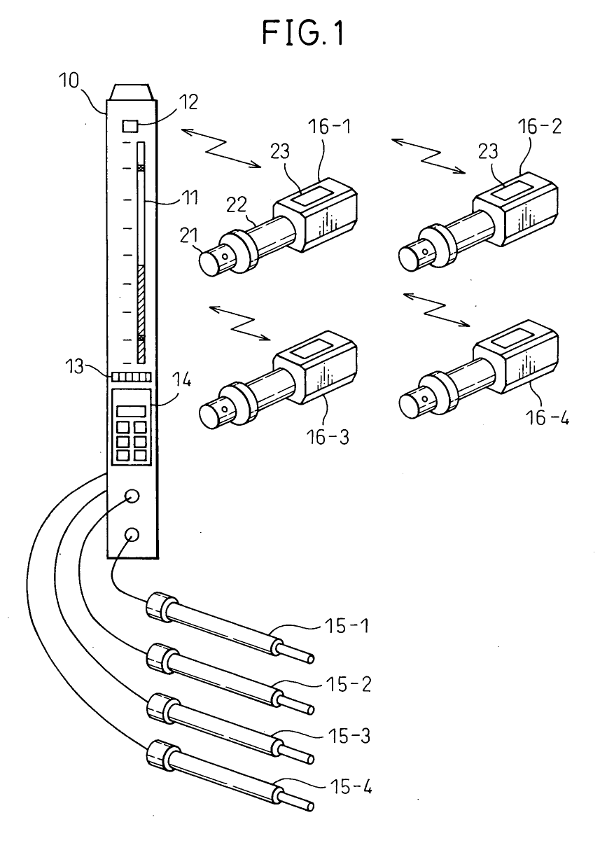

FIG. 1 is a diagram showing the entire con-figuration of a dimension measuring system in an embodiment of the present invention. As shown schematically, the dimension measuring system comprises a column 10, four pencil type gages 15-1 to 15-4 connected to the column 10 by a cable (cable communication), and four hand gages 16-1 to 16-4 connected to the column 10 by radio communication. The pencil type gages 15-1 to 15-4 detect the displacement of a probe at the front end with a differential transformer. The hand gages 16-1 to 16-4 are used for measuring an inner diameter and measure an inner diameter by detecting the displacement of two probes provided in the diameter direction with a differential transformer, and are driven by a battery. The column 10 comprises a bar graph 11, a gage number display unit 12 for displaying the gage number that displays a dimension measurement displayed in the bar graph 11, a dimension measurement display unit 13 for displaying the dimension measurement displayed in the bar graph 11 in digital, and a membrane keyboard 14 for performing various operations. The column 10 is provided with connectors for connecting the pencil type gages 15-1 to 15-4, two at the front surface and two at the back surface, and the back surface is further provided with various connectors such as a power source terminal, a power source switch, an RS-232C port, etc. On the top of the column 10, a radio circuit for performing radio communication with the hand gages 16-1 to 16-4 is provided.

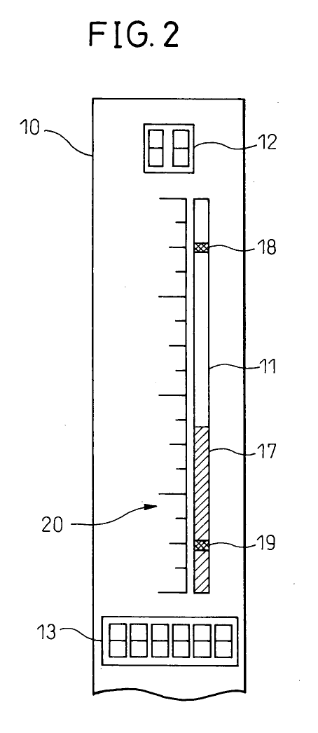

FIG. 2 is a diagram showing the detail of the portion of the bar graph 11 at the front surface of the column 10. As shown schematically, the bar graph 11 is capable of color display and displays a dimension measurement by a bar 17 and, at the same time, an upper limit value 18 and a lower limit value 19 of a tolerance in a different color. For example, the bar graph 11 displays in green when a dimension measurement is within the tolerance, displays in red when outside the tolerance, and displays the upper limit value 18 and the lower limit value 19 of the tolerance in orange. At the side of the bar graph 11, a scale 20 is marked. The bar graph 11 displays a specified dimension measurement among the dimension measurements read from the pencil type gages 15-1 to 15-4 and the hand gages 16-1 to 16-4.

Selection of an operation mode, direction of a dimension measurement to display from the outside, inputting of a measurement range and a tolerance of each dimension measurement, etc., are performed by operating the membrane keyboard 14 while watching the display 12. Further, these operations can also be performed by a computer for control (not shown) capable of communication via an RS-232C port. Furthermore, the column 10 reads a dimension measurement from each gage and sends it to the computer for control via an RS-232C port according to the direction of an operator. A dimension measurement to be sent to the computer for control is not limited to the data displayed in the column 10, and for example, there may be a case where a dimension measurement is read from the gage by the column 10 and sent to the computer for control without being displayed in the column 10.

A modification example in which a computer for control is incorporated in the column 10 or a modification example in which a connector for connecting the pencil type gages 15-1 to 15-4 and a radio circuit for radio communication with the hand gages 16-1 to 16-4 are provided in a computer for control and a display in the bar graph of the column 10 is produced by a display device of the computer for control, are also possible. Here, such a combination of the column 10 and the computer for control as in these modification examples is also regarded as that belonging to the range of the column. By the way, the hand gages 16-1 to 16-4 correspond to the portable dimension measurement device.

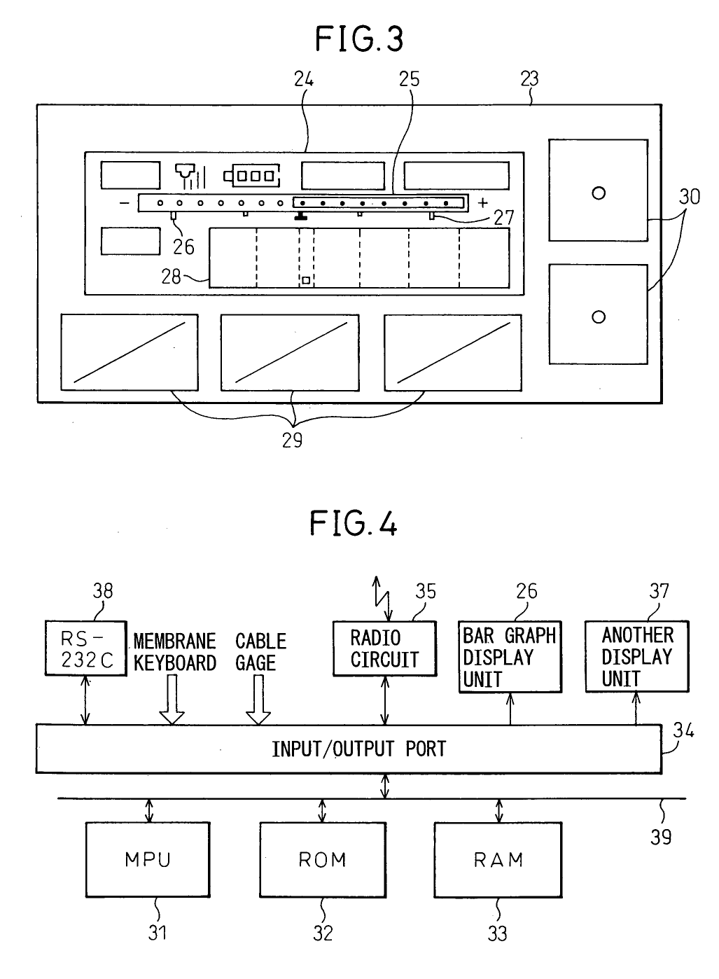

As shown in FIG. 1, each of the hand gages 16-1 to 16-4 has an operation section 23 constituted of a display unit of LCD and a membrane keyboard. FIG. 3 is a diagram showing the detail of the operation section 23 of the hand gage. As shown schematically, the operation section 23 has an LCD display unit 24 constituting a display section, a membrane keyboard 29, and a membrane keyboard with indicator 30. The LCD display unit 24 displays a bar graph 25 for displaying a dimension measurement of the hand gage, an upper limit value 27 and a lower limit value 26 of a tolerance, a digital value 28 of a dimension measurement, the charged state of a battery, radio communication conditions, a hold state of a dimension measurement, etc.

Selection of an operation mode of each hand gage, direction of a dimension measurement to display from the outside, inputting of a measurement range and a tolerance of each dimension measurement, etc., are performed by operating the membrane keyboard 29 and the membrane keyboard with indicator 30 while watching the LCD display unit 24. As described above, each hand gage has the display unit and the key for operation, therefore, it can be used independently without being connected to the column 10.

FIG. 4 is a diagram showing a configuration of a computer system for performing processing in a variety of ways including display processing in the column 10. As shown schematically, a micro processor (MPU) 21, a ROM 32, a RAM 33, an input/output port 34, etc., are connected via a bus 39. To the input/output port 34, an RS-232C communication port 38 to be connected to a computer for control, a membrane keyboard, a radio circuit 35 for communication with the pencil type (cable) gages 15-1 to 15-4 and the hand gages 16-1 to 16-4, the bar graph display unit 26, another display unit 37, etc., are connected. Such a computer system is widely known, therefore, a detailed explanation is not given here.

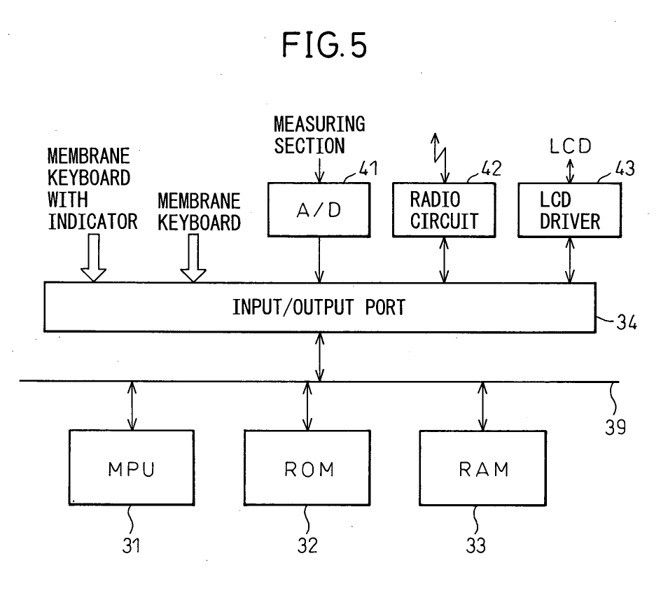

FIG. 5 is a diagram showing a configuration of a computer system provided to each of the hand gages 16-1 to 16-4 for performing processing in a variety of ways including display processing. As shown schematically, the computer system of the hand gage in FIG. 5 has a configuration similar to that of the computer system of the column in FIG. 4, however, differ in that the RS-232C communication port 38 and the cable gages are not connected, an LCD display unit and its driver are connected instead of the bar graph display unit 26 and the other display unit 37, and an A/D converter 41 for converting an analog measurement signal into a digital measurement signal is connected.

As described above, the hand gages 16-1 to 16-4 are driven by a battery and connected to the column 10 by radio communication. Therefore, they can be carried freely but the range in which radio communication is possible between the column 10 and the hand gages 16-1 to 16-4 is limited by the strength of electromagnetic waves and the presence of obstructions in the way. The range is, for example, a circle with a radius of 10 m with the column 10 at its center. In the present embodiment, the hand gages 16-1 to 16-4 move to a single mode in which they operate independently of the column 10 when radio communication with the column 10 becomes unavailable, and return to a connection mode in which they send dimension measurements to the column 10 when radio communication with the column 10 becomes available again.

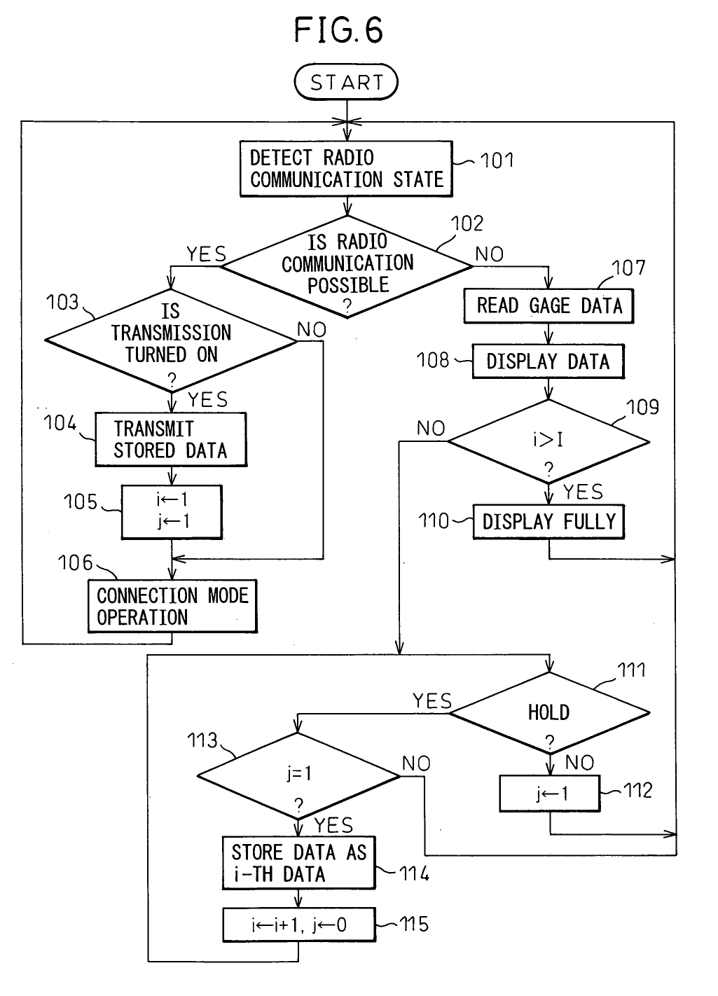

FIG. 6 is a flow chart showing a control relating to the transition between the single mode and the connection mode in the hand gages 16-1 to 16-4.

In step 101, a radio communication state is detected. In step 102, whether the detected radio communication state is capable of radio communication is judged. If the state is capable of communication, the procedure proceeds to step 103 and whether transmission is directed by a key operation is judged. If transmission is directed, the procedure proceeds to step 104 where stored data is transmitted. Transmission of the stored data is performed after interruption processing is done to the column 10 and a communication state between the column 10 and the hand gage is established. When transmission is directed in a state of in which there is no stored data, no substantial processing is performed. Then, in step 105, 1 is input to variables i and j for initialization and the procedure proceeds to step 106. The variable i indicates the number of pieces of stored data and the variable j is one for controlling the stored data not to be stored in duplicate. If transmission is not directed in step 103, the procedure proceeds to step 106. In step 106, after the gage data is read and displayed and the operation of connection mode such as transmission of data to the column etc. is performed, the procedure returns to step 101.

The above-mentioned operations are explained briefly here. When a state of not being capable of radio communication changes into a state of being capable of radio communication, the operation of the normal connection mode is performed and after the stored data is transmitted upon receipt of a direction to transmit, the normal connection mode is returned and the connection mode is maintained afterward until a state of not being capable of radio communication is brought about.

If the state is judged to be not capable of communication in step 102, the gage data is read in step 107 and the data is displayed on the LCD 24 of the hand gage in step 108. In step 109, whether the variable i is greater than an upper limit I is judged, which is the number of pieces of data that can be stored. If the variable i is greater than the upper limit I, that the data storage is in a full state is displayed in step 110, then, the procedure returns to step 101.

If the variable i is judged to be less than the upper limit I in step 109, whether the hold state is directed by the membrane keyboard is judged in step 111. The hold state is directed by the membrane keyboard and, when the hold state is directed, the state in which the dimension measurement at that time is displayed is maintained and at the same time, the displayed dimension measurement is stored in the memory. If the hold state is not directed, the procedure proceeds to step 112 where the variable j is incremented by 1 and the procedure returns to step 101.

If the hold state is directed, whether the variable j is 1 is judged in step 113. If not 1, the procedure returns to step 101 and if 1, the procedure proceeds to step 114. In step 114, the displayed data is stored as the i-th data and i is incremented by 1 in step 115 and 0 is input to j, and the procedure returns to step 111.

The above-mentioned operations are briefly explained here. When a state of not being capable of radio communication is brought about, data is displayed on the LCD 24 of the hand gage and the single mode is entered in which data is not transmitted to the columns. Then, when the hold state is directed, the data is stored. Once data is stored, the state is maintained until the hold state is released and storing of new data is not performed. When the hold state is released, a state in which data is displayed on the LCD 24 of the hand gage is returned. When the limit of the amount of data that can be stored is exceeded, that the data is in a full state is displayed and storing of new data is not performed.

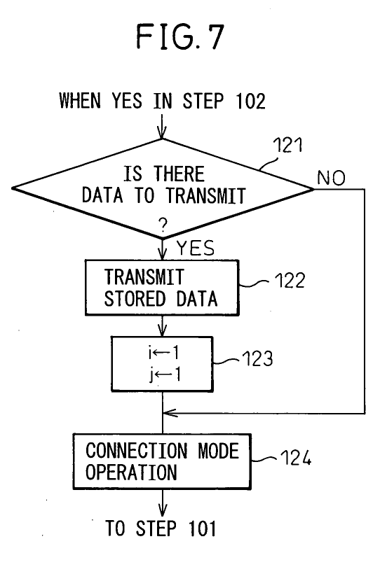

In the above-mentioned example, after the state of not being capable of radio communication changes into the state of being capable of radio communication, and when transmission is directed, the stored data is transmitted. However, it may also be possible to automatically transmit the stored data when the state of not being capable of radio communication changes into the state of being capable of radio communication. FIG. 7 is a flow chart showing the processing for this and the processing is performed instead of processing in steps 103 to 106 in FIG. 6.

In step 102, if the state is judged to be capable of communication, the procedure proceeds to step 121 where whether there is stored data is judged. When there is no stored data, the procedure proceeds to step 124. When there is stored data, the procedure proceeds to step 122 where the stored data is transmitted and 1 is input to the variables i and j for initialization in step 105, then the procedure proceeds to step 124. In step 124, after the gage data is read and displayed and the operation of connection mode such as transmission of data to the column etc. is performed, the procedure returns to step 101.

In the processing in FIG. 7, if the state of not being capable of communication changes into the state of being capable of communication in a state in which there is stored data, steps 122 and 123 are performed and the stored data is transmitted to the column 10. After this, even if the state of being capable of communication continues, there is no stored data, therefore, the normal connection mode is entered.

As described above, according to the present invention, it is made possible to use a portable dimension measuring section connected to a base device (column) by radio communication even in a place where radio communication with the base device is not available, and to effectively utilize a dimension measurement measured in such a place, therefore, the range in which the dimension measuring system can be used is extended.

We claim:

1. A dimension measuring system comprising:
a portable dimension measuring device having a terminal radio device, a dimension measuring section for generating a dimension measurement, and a display unit for displaying the dimension measurement; and
a base device having a base radio device for performing radio communication with the terminal radio device, the portable dimension measuring device transmitting the generated dimension measurement to the base device, wherein:
the portable dimension measuring device comprises a radio communication sate detection circuit for detecting whether the terminal radio device is capable of communicating with the base radio device and, when in a state of not being capable of communicating with the base radio device, automatically stops the operation of transmission of the generated dimension measurement to the base device and at the same time, displays the generated dimension measurement on the display unit and, when a state of being capable of communicating with the base radio device is brought about, automatically resumes the operation of transmission of the generated dimension measurement to the base device.

2. The dimension measuring system as set forth in claim 1, wherein the portable dimension measuring device comprises a display unit for indicating whether or not communication with the base measurement device is possible.

3. The dimension measuring system as set forth in claim 1, wherein the portable dimension measuring device comprises a battery and is driven by the battery.

4. The dimension measuring system as set forth in claim 1, wherein a plurality of the portable dimension measuring devices are connected to the single base device by radio communication.

5. A dimension measuring system comprising:
a portable dimension measuring device having a terminal radio device and a dimension measuring section for generating a dimension measurement; and
a base device having a base radio device for performing radio communication with the terminal radio device, the portable dimension measuring device transmitting the generated dimension measurement to the base device, wherein:
the portable dimension measuring device comprises a radio communication state detection circuit for detecting whether the terminal radio device is capable of communicating with the base radio device and a measurement storage circuit for storing the dimension measurement and, when in a state of not being capable of communicating with the base radio device, stores the dimension measurement in the measurement storage circuit.

6. The dimension measuring system as set forth in claim 5, wherein the portable dimension measuring device comprises a display unit for indicating whether or not communication with the base measurement device is possible.

7. The dimension measuring system as set forth in claim 5, wherein the portable dimension measuring device comprises a display unit for displaying the dimension measurement.

8. The dimension measuring system as set forth in claim 5, wherein the portable dimension measuring device comprises a storage operation switch and stores the dimension measurement in the measurement storage circuit in accordance with the operation of the storage operation switch.

9. The dimension measuring system as set forth in claim 5, wherein the portable dimension measuring device transmits the dimension measurement stored in the measurement storage circuit to the base device after the state of not being capable of communicating with the base radio device changes into the state of being capable of communicating therewith.

10. The dimension measuring system as set forth in claim 9, wherein the portable dimension measuring device comprises a transmission operation switch and transmits the dimension measurement stored in the measurement storage circuit to the base device in accordance with the operation of the transmission operation switch.

11. The dimension measuring system as set forth in claim 9, wherein the portable dimension measuring device automatically transmits the dimension measurement stored in the measurement storage circuit to the base device when the state of not being capable of communicating with the base radio device changes into the state of being capable of communicating therewith.

12. The dimension measuring system as set forth in claim 5, wherein the portable dimension measuring device comprises a battery and is driven by the battery.

13. The dimension measuring system as set forth in claim 5, wherein a plurality of the portable dimension measuring devices are connected to the single base device by radio communication.
